(19) United States
(12) Patent Application Publication
(10) Pub. No.: US 2005/0029417 A1
(43) Pub. Date: Feb. 10, 2005

(54) Mounting bracket for a rotary pump

(76) Inventors: Richard Scheps, Sharon (CA); Mark Lekhter, Toronto (CA); Predrag Banjanin, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/636,629

(22) Filed: Aug. 8, 2003

(51) Int. Cl. F16M 11/00

(52) U.S. Cl. 248/201

(57) ABSTRACT

A mounting bracket is provided for mounting a vacuum pump to a spectrometer. The vacuum pump has a mounting flange, with a locking rib thereon. The mounting bracket has a body and a grip. The body has a locking flange shaped to engage the locking rib, a means for fastening the body to the spectrometer, and a grip biasing surface. The grip has a pump engagement surface for engaging the vacuum pump, and a guide surface for engaging the grip biasing surface.

### FIELD OF THE INVENTION

The invention relates to mounting devices for rotary pumps, and more particularly to mounting devices for high-speed rotary vacuum pumps.

### BACKGROUND OF THE INVENTION

Rotary pumps are pumps which employ a rotating member, ie. a rotor, within a stationary housing. Such pumps are commonly used in many industries for many different functions. For example, some mass-spectrometers employ high-speed, turbo pumps to create a vacuum within one or more chambers. Typically, the pumps are mounted to a housing on the mass-spectrometer in fluid communication with the chamber to be evacuated.

A typical prior art mounting system for a high-speed turbo pump 10 on a machine 12, such as a mass spectrometer, is shown in FIG. 1a. The pump 10 has an inlet mounting flange 14, which is used for mounting the pump 10 to a machine, such as a mass spectrometer. The inlet mounting flange 14 is generally annular in shape about an axis A. The inlet mounting flange 14 has a machine-facing side 16, an away-facing side 18 and a circumferential surface 20. The away facing side 18 has a radial surface 21, and has a rib 22 that extends generally axially outwards from the away-facing side 18. The rib 22 may be positioned at the outermost periphery of the flange 14, as shown in FIG. 1a.

The mounting system typically includes two or more mounting claws 24, which are spaced evenly around the perimeter of the inlet mounting flange 14 on the pump 10. The mounting claws 24 have an engagement surface 26 that is generally hook-shaped in profile, and corresponds to the shape of the on the inlet mounting flange 14. The mounting claws 24 are bolted to the housing of the mass spectrometer 12 by means of fasteners 27 thereby securing the flange 14, and in turn, the pump 10 in place.

Reference is made to FIG. 1b, which shows the engagement of the claw 24 on the inlet mounting flange 14. As shown in FIG. 1b, the engagement surface 26 extends in a straight line, and as a result, it can only make limited contact with the curved axially extending surfaces of the flange 14, such as the circumferential surface 20 and the inside surface of the circular rib 22.

For some rotary pumps, such as high-speed turbo pumps, sudden stoppage of the rotor (not shown) due to a mechanical failure can cause a relatively large amount of rotational energy to be transferred from the rotor to the pump housing, shown at 28, in a relatively short period of time. If the mounting claws 24 do not hold the flange 14 sufficiently solidly, the pump housing 28 can be caused to rotate. During rotation, the housing can suddenly dig in to one of the mounting claws 24, resulting in the flange 14 becoming seized against the mounting claw 24. The large amount of rotational energy that continue to exist in the pump housing 28 can causing the housing to physically bend or break. In addition, the housing of the mass spectrometer 12 can also be damaged.

To reduce the likelihood of damage to the pump or the machine from such a pump failure, it is desirable to provide a mounting system that resists the rotation of the housing during such a pump failure.

### SUMMARY OF THE INVENTION

In a first aspect, the invention is directed to a mounting bracket for mounting a vacuum pump to a spectrometer. The vacuum pump has a mounting flange, with a locking rib thereon. The mounting bracket has a body and a grip. The body has a locking flange shaped to engage the locking rib, a means for fastening the body to the spectrometer, and a grip biasing surface. The grip has a pump engagement surface for engaging the vacuum pump, and a guide surface for engaging the grip biasing surface.

In a second aspect, the invention is directed to a mounting device for mounting a rotary vacuum pump to a machine. The rotary vacuum pump has an inlet mounting flange that is generally circular about an axis. The inlet mounting flange has a machine-facing side, an away-facing side, and a circumferential surface. The circumferential surface is generally cylindrical about the axis. The mounting device includes a body and a grip. The body is fixably connectable with respect to the machine. The body has a first engagement surface thereon for engaging the away-facing side of the inlet mounting flange. The body has a first guide surface thereon. The grip has a second engagement surface thereon for engaging the circumferential surface of the inlet mounting flange. The grip has a second guide surface thereon. The grip is slideably connectable to the body. The first and second guide surfaces are configured to cooperate to drive the grip into the circumferential surface of the inlet mounting flange to inhibit rotation of the inlet mounting flange, when the inlet mounting flange rotates in a selected direction about the axis.

### BRIEF DESCRIPTION OF THE DRAWINGS

A preferred embodiment of the present invention will now be described in detail with reference to the drawings, in which:

FIG. 1a is an exploded perspective view of a rotary pump and a mounting system of the prior art;

FIG. 1b is a sectional view of a portion of the rotary pump and mounting system shown in FIG. 1a;

FIG. 2 is a partial sectional side view of a mounting system comprising a plurality of mounting brackets in accordance with a first embodiment of the present invention, shown retaining a rotary pump in place against a machine;

FIG. 3 is an exploded perspective view of one of the mounting brackets shown in FIG. 2;

FIG. 4a is a magnified view of a portion of the mounting device shown in FIG. 2;

FIG. 4b is a magnified view of a variant of the portion of the mounting device shown in FIG. 4a;

FIG. 5a is a magnified view of a portion of the mounting device shown in FIG. 2;

FIG. 5b is a magnified view of a variant of the portion of the mounting device shown in FIG. 5a;

FIG. 6 is a plan view of the mounting device shown in FIG. 3 shown retaining the flange of a pump, wherein the flange is shown as transparent for greater clarity;

FIG. 7 is a side view of a mounting device in accordance with another embodiment of the present invention;

FIG. 8 is a perspective view of a mounting device in accordance with yet another embodiment of the present invention; and

FIG. 9 is a plan view of the mounting device shown in FIG. 8 retaining the flange of a pump, whereby the flange as transparent for greater clarity.

### DETAILED DESCRIPTION OF EXEMPLARY EMBODIMENTS

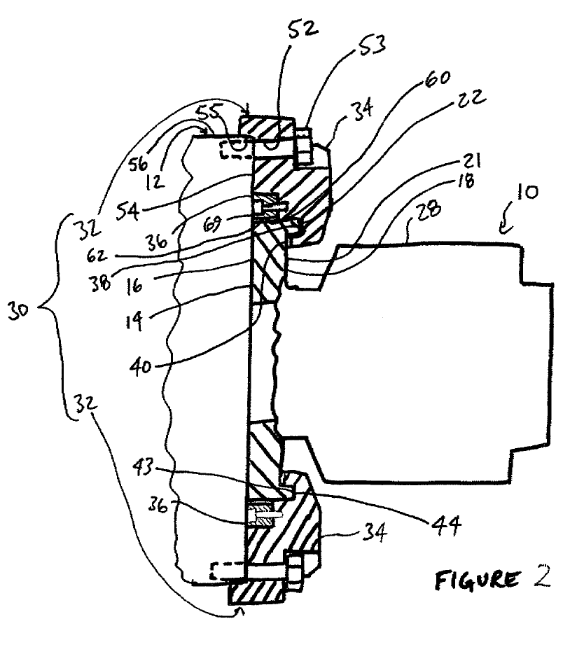

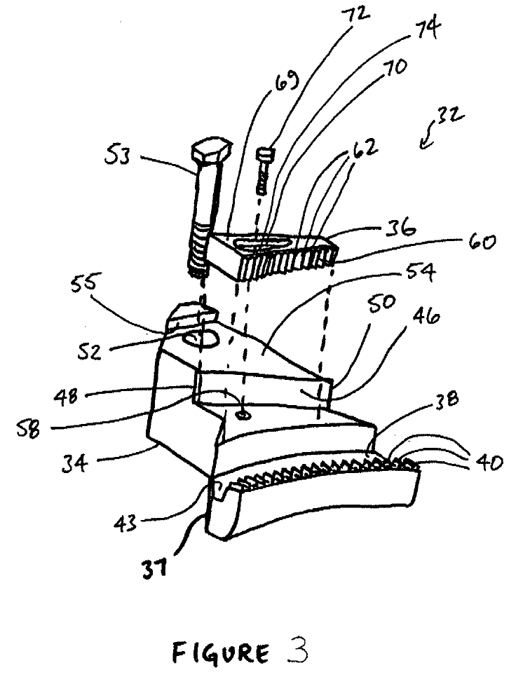

Reference is made to FIGS. 2 and 3, which show a mounting system 30 in accordance with a first embodiment of the present invention. The mounting system 30 comprises a plurality of mounting devices 32, which may also be referred to as mounting brackets 32 and which provide improved resistance to rotation of the pump housing 28 during a pump failure wherein rotational energy is transferred from pump rotor (not shown) to the pump housing 28. Providing increased resistance to rotation of the pump housing 28 during such a pump failure reduces the risk of damage to the machine 12 to which the pump 10 is attached.

The mounting devices 32 or mounting brackets 32 each include a body 34 and a grip 36. The body 34 has a first engagement surface 38 that is positioned on a locking flange 37, which engages a portion of the away-facing side 18 (see FIG. 2) of the flange 14. In particular, the first engagement surface 38 may have a generally hooked configuration in profile to engage and capture the rib 22 and a portion of the radial surface 21 on the away-facing side 18.

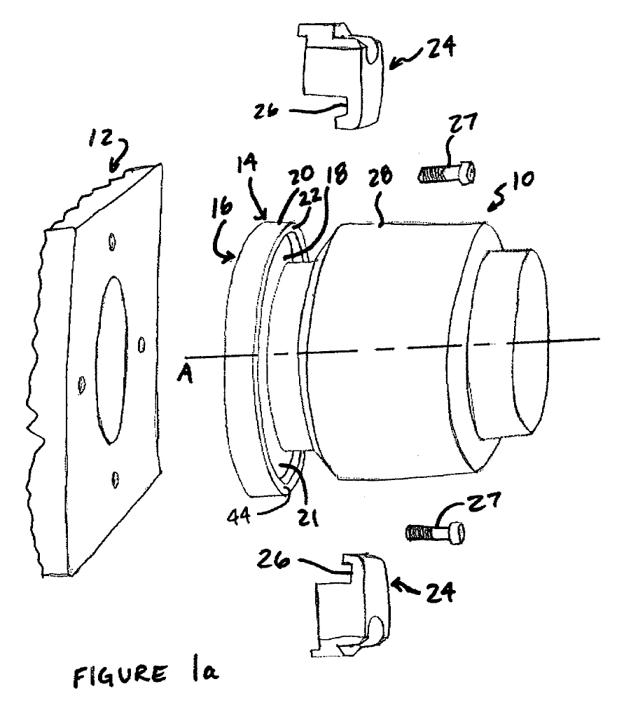

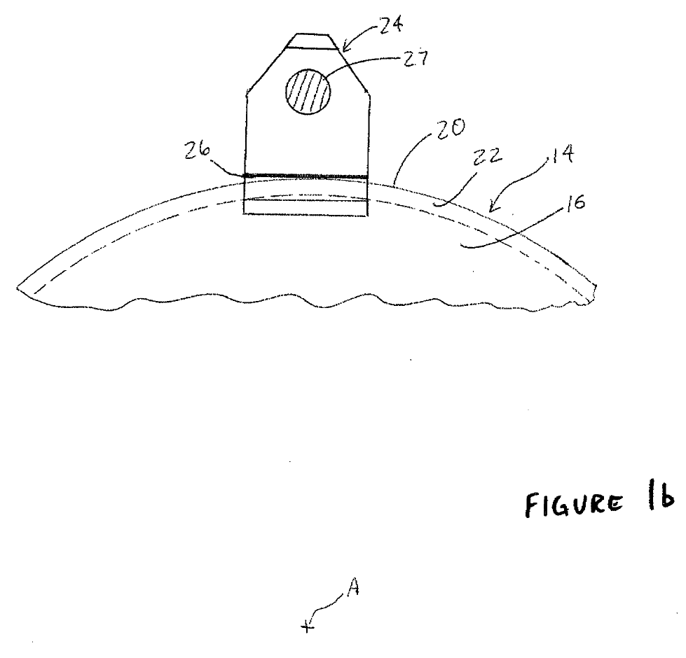

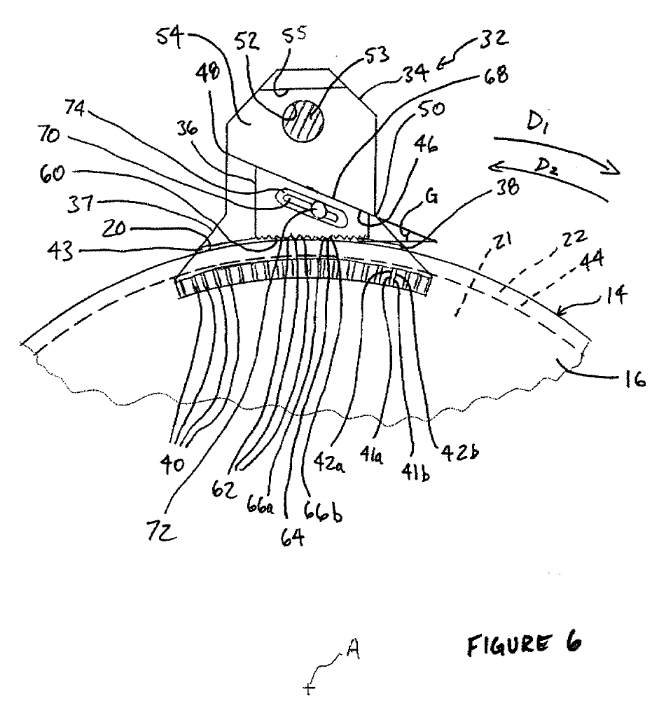

Reference is made to FIG. 6, which shows one of the mounting devices 32 in engagement with the flange 14. The first engagement surface 38 may be generally arcuate to generally match the circumferential curvature of the flange 14. By making the first engagement surface 38 arcuate, the engagement surface 38 has a greater surface area of contact with the flange 14, and in particular with the rib 22, relative to mounting claws of the prior art with straight engagement surfaces, such as mounting claw 24, as shown in FIG. 1a.

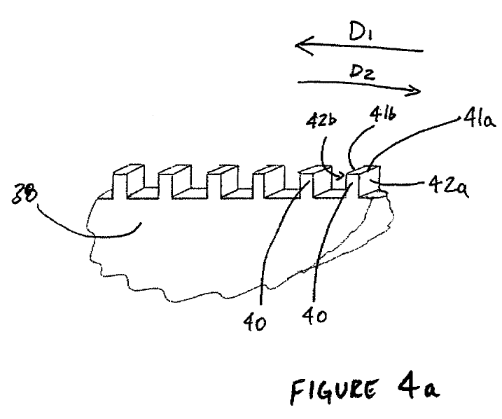

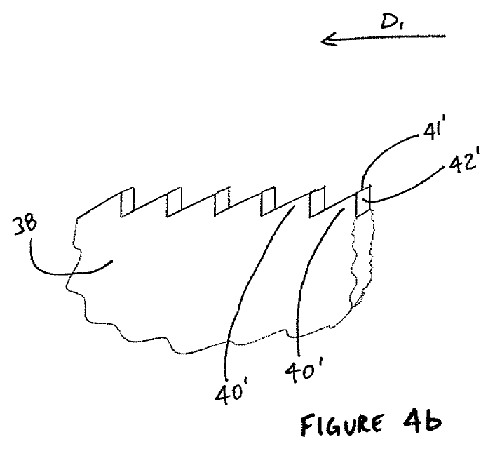

The engagement surface 38 may have a plurality of teeth 40 thereon. The teeth 40 provide the engagement surface with increased grip on the inlet mounting flange 14. Referring to FIG. 4a, the teeth 40 may have any suitable shape to provide increased grip. For example, the teeth 40 may each have a first engagement edge 41a, which is positioned at the end of a first leading edge surface 42a. The first engagement edge 41a is the edge of the tooth 40 that is primarily responsible for causing the tooth 40 to grip the flange 14 (see FIG. 6), when the flange 14 is urged to rotate in a first direction indicated by the arrow D1. The engagement edge 41a is generally linear and extends across the length of the tooth 40.

Referring to FIG. 6, the teeth 40 may be arranged on the engagement surface 38 so that the first engagement edges 41a extend generally radially from the axis A (see FIG. 6). In doing so, the engagement edges 41a extend in a direction that is generally perpendicular to the direction of travel of the radial surface 21 of the flange 14 during flange rotation. Such a configuration provides increased grip relative to an embodiment wherein only some or none of the engagement edges 41a are perpendicular to the direction of travel of the radial surface 21 of the flange 14. Nonetheless, embodiments wherein the engagement edges 41a are not perpendicular to the direction of travel of the flange 14 are contemplated to fall within the scope of the invention.

The angle of the leading edge surface 42a with respect to the radial surface 21 of the flange 14 during engagement, at least in part determines the ultimate grip that the engagement edge 41a can have with the flange 14. The leading edge surface 42a may be made to be generally perpendicular to the radial surface 21 of the flange 14.

Each tooth 40 may further include a second engagement edge 41b, positioned on a second leading edge surface 42b. The second engagement edge 41b and second leading edge surface 42b may be configured similarly to the first engagement edge 41a and 42a, except that they function to grip the radial surface 21 of the flange 14, when the flange 14 rotates in a direction D2, which is opposite to the direction D1.

Thus, the teeth 40 are configured to grip the flange 14 regardless of the direction in which the flange 14 rotates during a pump failure.

Many pumps, however, operate in a single direction of rotation only. Thus, any pump failure on such pumps would impart rotational energy to the pump housing 28 for rotation in one direction only. Referring to FIG. 4b, a plurality of teeth 40′ may be used instead of teeth 40 (FIG. 4a) on the engagement surface 38, for use with single direction pumps. The teeth 40′ have an engagement edge 41′, positioned on a leading edge surface 42′. The engagement edge 41′ and leading edge surface 42′ may be configured similarly to the engagement edge 41a and 42a in the embodiment shown in FIG. 4a, and function to grip the radial surface 21 of the flange 14 (FIG. 6), when the flange 14 rotates in the direction D1.

However, the teeth 40′ lack a second engagement edge and a second leading edge surface, and are instead generally shaped like a right angle triangle when viewed in a radial direction, ie a direction parallel to the engagement edge 41′. Thus, the teeth 40′ are generally unidirectional in that they are configured to resist rotation of the flange 14 (FIG. 6) in the direction D1 only. The triangular shape of the teeth 40′ provides added strength for resisting bending and deformation when resisting rotation of the flange 14 (FIG. 6) during a pump failure.

Referring to FIG. 2, the teeth 40 (or the teeth 40′; of FIG. 4b) may be positioned on the portion of the engagement surface 38 that engages the flange 14 adjacent the rib 22. In an alternative embodiment (not shown), however, the teeth 40 (or 40′) may be positioned on a portion of the engagement surface 38 that engages some portion of the rib 22. For example, the teeth 40 or 40′ may be positioned on a portion 43 of the engagement surface 38, which engages the edge of the rib 22, shown at 44.

Referring to FIG. 3, the body 34 has a first guide surface 46. Referring to FIG. 6, the first guide surface 46 generally faces the circumferential surface 20 of the flange 14. The first guide surface 46 extends linearly between a first end 48 and a second end 50. The second end 50 is closer to the circumferential surface 20 of the flange 14, than is the first end 48, so that the first guide surface 46 extends at an acute angle G, with respect to the circumferential surface 20. The angle G may be any suitable angle for guiding or biasing the grip 36 into firm engagement with the flange 14. To some extent, the angle G can be selected depending on the diameter of the flange 14, and the overall size of the mounting device 32. For example, the angle G may be anywhere within the range of 5-25 degrees. In one embodiment of the present invention, where flange 14 has an outer diameter of 180 mm, the angle G is approximately 15 degrees. A skilled person will be able to select an appropriate angle G for a particular embodiment of the present invention.

Referring to FIG. 2, the body 34 includes a mounting aperture 52. The aperture 52 is used for the pass-through of a fastener 53, such as a bolt, when mounting the mounting device 32 to the machine 12.

The body 34 has a machine engaging surface 54, which is the surface of the body 34 that engages the machine 12 when the mounting device 32 is mounted to the machine 12. On the machine engaging surface 54, the body 34 includes an optional shoulder 55, which is used to engage a side face 56 or complementary orifice (not shown) on the machine 12. The engagement of the shoulder 55 with the side face 56 (see, FIG. 2) assists in fixing the mounting device 32 in position on the machine 12. The mounting aperture 52 and the shoulder 55 may alternatively be replaced by any suitable mounting means for the mounting device 32.

Referring to FIG. 3, the body 34 may further include another mounting aperture 58, which is used for mounting the grip 36 to the body 34. It is alternatively possible, however, for the body 34 to include other suitable means for slideably receiving the grip 36, as will be discussed further below.

Referring to FIG. 6, the grip 36 is used to grip the circumferential surface 20 of the flange 14. The grip 36 cooperates with the body 34 to provide firm engagement with the flange 14. More particularly, the engagement force of the grip 36 with the flange 14 increases as the flange 14 rotates in the direction D1.

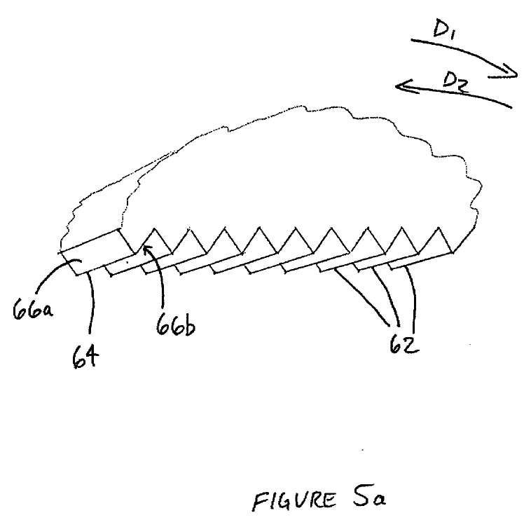

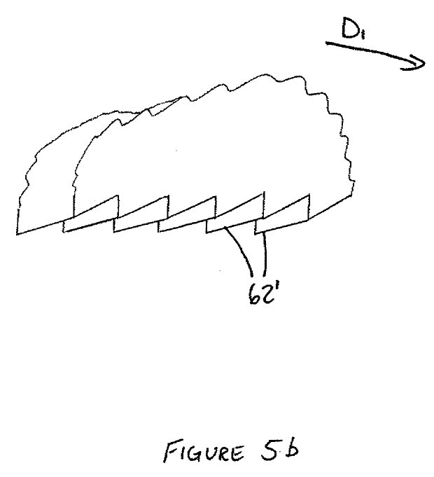

The grip 36 includes a second engagement surface 60. The second engagement surface 60 may be generally planar and is positioned to engage the circumferential surface 20 of the flange 14. The second engagement surface 60 includes a plurality of teeth 62. Referring to FIG. 5a, the teeth 62 each have an engagement edge 64, which is positioned on a leading edge surface 66a. The engagement edge 64 may extend linearly across the length of each tooth 62, and may be positioned to be generally perpendicular to the direction of travel of the circumferential surface 20 of the flange 14.

Referring to FIG. 6, the leading edge surface 66a may extend at an acute angle with respect to the circumferential surface 20, such as an angle of approximately 60 degrees. Furthermore, the teeth 62 may each have a trailing edge surface 66b that extends at an acute angle of approximately 60 degrees with respect to the circumferential surface 20, giving a triangular profile to the teeth 62 when viewed in an axial direction (ie. in a direction parallel to the axis A, and parallel to the engagement edge 64) as shown in FIG. 5a. By providing the teeth 62 with such a profile, they are generally stronger and more resistant to deformation than the teeth 40 shown in FIG. 4a. The dimensions provided here are merely exemplary and teeth 62 may have a different shape, as discuss below. Teeth 62 may have any shape that will engage flange 14.

Referring to FIG. 5b, it is alternatively possible for the second engagement surface 60 to have a plurality of teeth 62′ instead of the teeth 62 of FIG. 5a. The teeth 62′ may be similar in configuration to the teeth 40′ (see FIG. 4b), and thus have improved grip when the flange rotates in the direction D1, relative to the teeth 62 (FIG. 5a). The teeth 62′ are unidirectional, however.

Referring to FIG. 6, the grip 36 further includes a second guide surface 68. The second guide surface 68 is positioned to engage the first guide surface 46, when the grip 36 is mounted to the body 34.

Referring to FIG. 2, the grip 36 has a machine facing side 69, which faces the machine 12 when the grip 36 is mounted to the body 34. The grip 36 is preferably configured so that the machine facing side 69 does not extend outwards past the machine engaging surface 54 on the body 34. The grip 36 may, for example, be configured to be flush with the machine engaging surface 54, so that the machine facing side 69 contacts the machine 12.

Referring to FIG. 3, the grip 36 may further include an aperture 70 for the pass-through of a fastener 72. The aperture 70 may be elongate in a direction parallel to the second guide surface 68. By making the aperture 70 elongate and by providing the first and second guide surfaces 46 and 68, the grip 36 is permitted to move in a direction parallel to the first and second guide surfaces 46 and 68.

The aperture 70 may have a shoulder 74 therein for receiving the head of the fastener 72. The shoulder 74 may be positioned sufficiently deep so that the head of the fastener 72 does not extend outwards above the machine facing surface 69.

The fastener 72 is used to sildeably mount the grip 36 to the body 34. The fastener 72 may be any suitable type of fastener, such as a nylon machine screw. The fastener 72 passes through the grip 36 and engages with the aperture 58 on the body 34. The fastener 72 may be made to be shearable, so that if the grip 36 is urged to move beyond the limits established by the elongate aperture 70, the fastener 72 can shear, so as to permit such movement.

Reference is made to FIG. 2. In use, the mounting system 30 is mounted to the machine 12 and holds the rotary pump 10 in place. In particular, the engagement surface 38 and in particular the teeth 40 (or 40′—see FIG. 4b) engage the flange 14. During use, if the pump 10 fails in a particular fashion, the rotational energy of the pump rotor (not shown) is transferred to the pump housing 28, which includes the flange 14. Referring to FIG. 6, the rotational energy transferred to the flange 14 urges the flange to rotate in the direction D1. As the flange 14 is urged to rotate, the engagement surface 38 and the teeth 40 (or the teeth 40;—see FIG. 4b) engage the flange 14 to resist the rotation. Furthermore, the teeth 62 (or 62′—see FIG. 5b) engage the circumferential surface 20 of the flange 14. As the flange 14 rotates, it drags the grip 36 therewith. As the grip 36 is dragged, the first and second guide surfaces 46 and 68 engage each other to drive or press the grip 36 progressively harder into the circumferential surface 20 of the flange 20, thereby increasing the resistance to the rotation of the flange 14. Thus, as the flange 14 rotates in the direction D1, the resistive force generated by the mounting device 32 increases, until the rotational force in the flange 14 is equaled by the resistive force in the mounting device 32. At this point, the flange 14 stops rotating. Because the mounting device 32 of the present invention provides improved resistance to the buildup of rotational kinetic energy in the pump housing 28, relative to mounting claws of the prior art, the magnitude of any jerking that may occur between the mounting device 24 and the flange 14 is reduced.

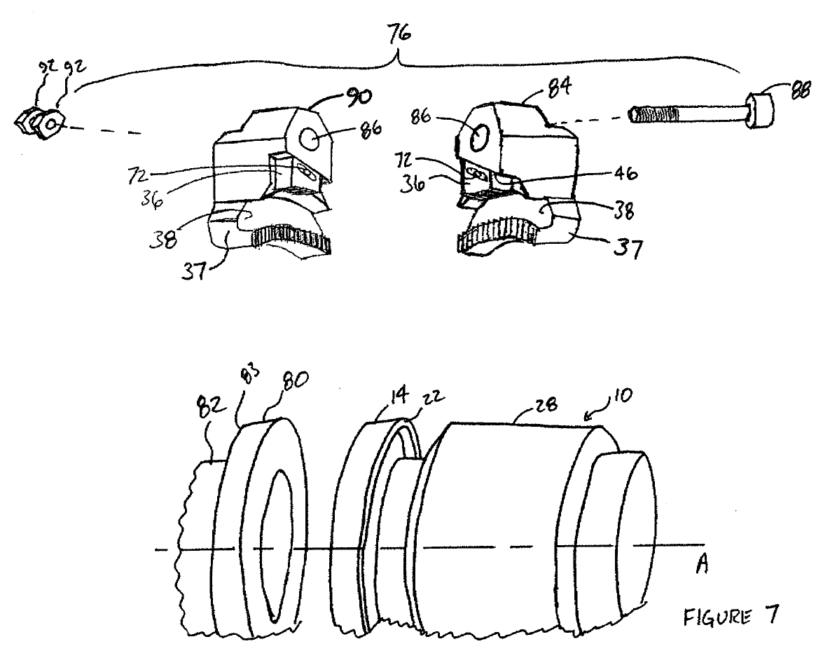

Reference is made to FIG. 7, which shows a mounting device 76, also called a mounting bracket 76, in accordance with another embodiment of the present invention. The mounting device 76 is similar to the mounting device 32, but is configured as a clamp. Instead of having an aperture for receiving a fastener for mounting to a wall of a machine 12 (see FIG. 2), the mounting device 76 is configured to mount to a flange 80 on a machine 82. The machine 82 may be a mass spectrometer, or any other machine that uses a rotary pump. The machine 82 may be similar to the machine 12 (see FIG. 2), except for the provision of a mounting flange 80 for receiving the pump 10. The mounting flange 80 may include a rib 83 that is similar to the rib 22.

The mounting device 76 includes a first body portion 84 that includes the first engagement surface 38 and the first guide surface 46, the aperture (not shown) for receiving the fastener 72 for mounting the grip 36 thereto, and an aperture 86 for the pass-through of the body of a clamping screw 88.

The mounting device 76 also includes a second body portion 90, which may be identical to the first body portion 84, and which may also have a grip 36 attached thereto. The grip 36 on the second body portion 90 is for engagement with the flange 80 on the machine 82.

The clamping screw 88 passes through the pas-through apertures 86 on the first and second body portions 84 and 90. A pair of nuts 92 may be mounted on the end of the fastener 88, to bring the first and second body portions 84 and 90 together against the flanges 14 and 80, and to retain the assembly together.

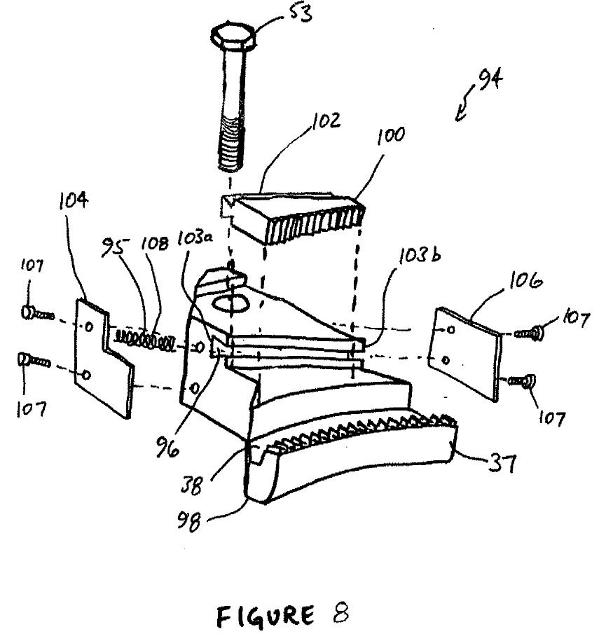

Reference is made to FIG. 8, which shows a mounting device 94, also called a mounting bracket 94, which has a variant of the first and second guide surfaces 46 and 68, and which includes a biasing mechanism 95, but is otherwise similar to the mounting device 32 shown in FIGS. 2-6.

The first guide surface on the mounting device 94 is shown at 96 and is positioned on a body 98. The first guide surface 96 may be a channel which is dove-tailed, and which slideably retains a grip 100, which has a complementary second guide surface 102, which is dove-tailed. The grip 100 may be similar to the grip 36 (FIGS. 2-6), except for how it is retained on the body 98.

The first guide surface 96 extends from a first end 103a to a second end 103b, and extends at a similar angle to the guide surface 46 of the body 34 in the embodiment shown in FIGS. 2-6.

The first guide surface 96 has a first end wall 104 and a second end wall 106. One or both of the first and second end walls 104 and 106 may be a separate piece that is attached to the rest of the body 98, by fasteners 107 for example thus facilitating the manufacture of the dove-tailed guide surface 96, and facilitating the installation of the grip 100 in the first guide surface 96.

The biasing mechanism 95 biases the grip 100 towards the second end wall 106 in any suitable way. For example, the biasing mechanism 95 may be a compression spring 108, which projects from the first end wall 104 and extends in the dove-tailed channel 96 to abut one end of the grip 100 pushing the grip 100 towards the second end wall 106.

The mounting device 94 has been described as generally being similar to the mounting device 32 (see FIGS. 2-6). It is possible for the mounting device 94 to be similar to the mounting device 84 (see FIG. 7).

In the embodiment shown in FIG. 8, a fastener is not required for the mounting of the grip 100 to the body 98, because the grip 100 is captured by the dove-tailed guide surface 96. Thus, the fastener 72, the elongate aperture 70 and the aperture 58 that are shown in the embodiment of FIGS. 2-6 are not required for the embodiment shown in FIG. 8.

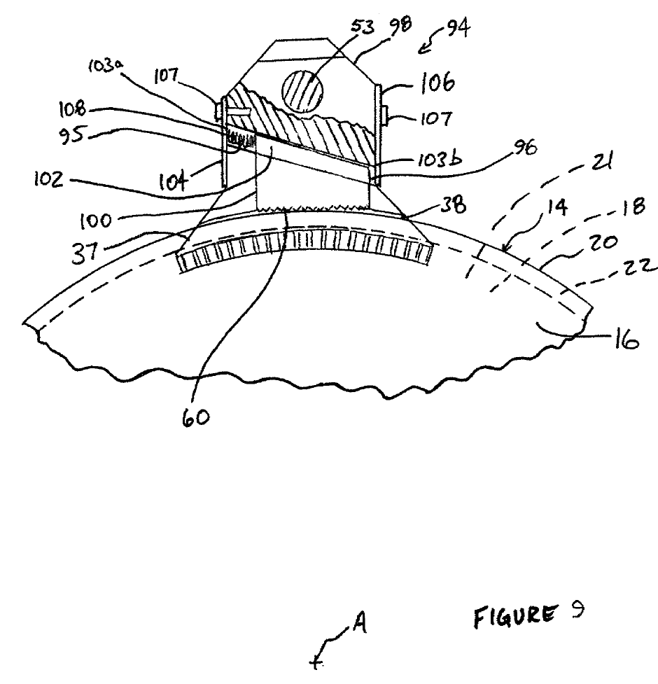

Reference is made to FIG. 9. In use, when the mounting device 94 is mounted to the machine 12 and captures the flange 14 of the pump 10, the grip 100 is maintained biased in engagement with the circumferential surface 20 of the flange 14, by means of the biasing mechanism 95. During a pump failure, when the flange 14 is urged to rotate, the biasing mechanism 95 reduces the likelihood of the grip 100 popping out of engagement with the flange 14 by moving towards the first end 103a of the guide surface 96.

In a preferred embodiment, the mounting system 30 is made up entirely of mounting devices 32. It is alternatively possible, however, for a mounting system of the present invention to be made up of some mounting devices of the prior art, and at least one of the mounting devices 32.

While the above description constitutes the preferred embodiments, it will be appreciated that the present invention is susceptible to modification and change without departing from the fair meaning of the accompanying claims.

The present invention has been described here by way of example only. Various modifications and variations may be made to these exemplary embodiments without departing from the spirit and scope of the invention, which is limited only by the appended claims.

1. A mounting bracket for mounting a vacuum pump to a spectrometer, wherein the vacuum pump has a mounting flange, the mounting flange having a locking rib, wherein the mounting bracket comprises:
i. a body having:
a. a locking flange shaped to engage the locking rib;
b. means for fastening the body to the spectrometer;
c. a grip biasing surface; and
ii. a grip having:
a. a pump engagement surface for engaging the vacuum pump;
b. a guide surface for engaging the grip biasing surface.

2. A mounting bracket as claimed in claim 1, wherein the grip is slideably mounted on the body.

3. A mounting bracket as claimed in claim 2, wherein the grip has an elongate aperture therethrough and a fastener passes through the elongate aperture and into the body.

4. A mounting bracket as claimed in claim 3, wherein the fastener is a shearable screw.

5. A mounting bracket as claimed in claim 2, wherein the grip is mounted in a channel formed in the body.

6. A mounting bracket as claimed in claim 2, wherein the channel is configured to capture the grip therein.

7. A mounting bracket as claimed in claim 6, wherein the channel has a dove-tail cross-sectional shape.

8. A mounting bracket as claimed in claim 1, wherein the grip biasing surface is configured to press the grip into the flange as a result of flange rotation in a selected direction.

9. A mounting bracket as claimed in claim 1, wherein the grip biasing surface has a first end and a second end and is shaped such that the grip is biased with greater force towards the flange when it is closer to the second end than when it is closer to the first end.

10. A mounting bracket as claimed in claim 9, wherein the mounting bracket further comprises a biasing mechanism for biasing the grip towards the second end of the grip biasing surface.

11. A mounting bracket as claimed in claim 9, wherein the biasing mechanism includes a compression spring mounted at the first end, wherein the compression spring abuts the grip.

12. A mounting bracket as claimed in claim 1, wherein the grip is moveable between a first position and a second position, wherein in the first position the grip is positioned to engage the flange with a first force, and wherein in the second position, the grip is positioned to engage the flange with a second force, and wherein the second force is greater than the first force.

13. A mounting bracket as claimed in claim 12, wherein, when a plurality of mounting brackets are used to mount the pump to the spectrometer, the combined second forces are sufficient to substantially arrest rotational movement of the pump in at least one direction of rotation.

14. A mounting bracket as claimed in claim 12, wherein the grip is configured to move from the first position to the second position in response to rotation of the vacuum pump in a selected direction of rotation.

15. A mounting bracket as claimed in claim 1, wherein the pump engagement surface has a plurality of teeth thereon.

16. A mounting bracket as claimed in claim 15, wherein the teeth have an engagement edge from engaging the flange, and the teeth are generally symmetrical when viewed in a direction parallel to the engagement edge.

17. A mounting bracket as claimed in claim 15, wherein the teeth have an engagement edge and the teeth are shaped generally as right-angle triangles when viewed in a direction parallel to the engagement edge, the right angle triangles each having a leading edge surface that is perpendicular to the flange.

18. A mounting bracket as claimed in claim 1, wherein the locking flange has a plurality of teeth thereon.

19. A mounting bracket as claimed in claim 18, wherein the teeth have an engagement edge from engaging the flange, and the teeth are generally symmetrical when viewed in a direction parallel to the engagement edge.

20. A mounting bracket as claimed in claim 18, wherein the teeth have an engagement edge and the teeth are shaped generally as right-angle triangles when viewed in a direction parallel to the engagement edge, the right angle triangles each having a leading edge surface that is perpendicular to the flange.

21. A mounting device for mounting a rotary vacuum pump to a machine, the rotary vacuum pump having an inlet mounting flange, wherein the inlet mounting flange is generally circular about an axis, the inlet mounting flange has a machine-facing side, an away-facing side, and a circumferential surface, the circumferential surface is generally cylindrical about the axis, the mounting device comprising:
(a) a body, wherein the body is fixably connectable with respect to the machine, the body having a first engagement surface thereon for engaging the away-facing side of the inlet mounting flange, the body having a first guide surface thereon; and
(b) a grip, the grip having a second engagement surface thereon for engaging the circumferential surface of the inlet mounting flange, the grip having a second guide surface thereon, wherein the grip is slideably connectable to the body, and wherein the first and second guide surfaces are configured to cooperate to drive the grip into the circumferential surface of the inlet mounting flange to inhibit rotation of the inlet mounting flange when the inlet mounting flange rotates in a selected direction about the axis.

22. A mounting device as claimed in claim 21, wherein the second engagement surface has a plurality of teeth extending therefrom.

23. A mounting device as claimed in claim 21, wherein the body has a body aperture therein for receiving a grip fastener, and the grip has a grip aperture therethrough, the grip aperture is sized to permit pass-through of a portion of the grip fastener for connection of the grip to the body, and wherein the grip aperture is elongate in a direction generally parallel to the second guide surface.

24. A mounting device as claimed in claim 23, wherein the grip fastener is shearable.

25. A mounting device as claimed in claim 21, wherein the first guide surface is a channel that is configured to slideably capture the grip.

26. A mounting device as claimed in claim 21, further comprising a biasing mechanism connected to the body, wherein the biasing mechanism is configured to bias the grip towards the inlet mounting flange.

27. A mounting device as claimed in claim 21, wherein the first engagement surface has a plurality of teeth extending therefrom.

28. A mounting device as claimed in claim 21, wherein the first engagement surface is arcuate to match the curvature of the inlet mounting flange.

29. A mounting bracket as claimed in claim 21, wherein the pump engagement surface has a plurality of teeth thereon.

30. A mounting bracket as claimed in claim 29, wherein the teeth have an engagement edge from engaging the flange, and the teeth are generally symmetrical when viewed in a direction parallel to the engagement edge.

31. A mounting bracket as claimed in claim 29, wherein the teeth have an engagement edge and the teeth are shaped generally as right-angle triangles when viewed in a direction parallel to the engagement edge, the right angle triangles each having a leading edge surface that is perpendicular to the flange.

32. A system for mounting a rotary vacuum pump to a machine, the rotary vacuum pump having an inlet mounting flange, wherein the inlet mounting flange is generally circular about an axis, the inlet mounting flange has a machine-facing side, an away-facing side, and a circumferential surface, the circumferential surface extends in a direction that is parallel to the axis, the system comprising a plurality of mounting devices, the plurality of mounting devices each including a body, wherein the body is fixably connectable with respect to the machine, the body having a first engagement surface thereon for engaging the away-facing side of the inlet mounting flange, wherein on at least one mounting device the body has a first guide surface thereon and wherein the at least one mounting device further includes a grip, the grip having a second engagement surface thereon for engaging the circumferential surface of the inlet mounting flange, the grip having a second guide surface thereon, wherein the grip is slideably connectable to the body, and wherein the first and second guide surfaces are configured to cooperate to drive the grip into the circumferential surface of the inlet mounting flange to inhibit rotation of the inlet mounting flange when the inlet mounting flange rotates in a selected direction about the axis.
